(19) United States
(12) Patent Application Publication
(10) Pub. No.: US 2008/0190311 A1
(43) Pub. Date: Aug. 14, 2008

(54) Printing Machine Comprising a Suction Device, Suction Device and Method For Changing a Printing Film

(76) Inventors: Wolfgang Dennstedt, Bern (CH); Andreas Zahnd, Zollikofen (CH)

Correspondence Address: RATNERPRESTIA, P O BOX 980, VALLEY FORGE, PA, 19482-0980, US

(21) Appl. No.: 11/596,167

(22) PCT Filed: May 6, 2005
(86) PCT No.: PCT/EP2005/004937

§ 371 Date: Dec. 3, 2007

(30) Foreign Application Priority Data
May 10, 2004 (DE) 10 2004 023 434.5

(51) Int. Cl. B41F 27/00

(52) U.S. Cl. 101/389.1

(57) ABSTRACT

A printing machine including a printing film carrier on which a first printing film and a second printing film can be applied, offset with respect to each other in an axial direction, and comprising a suction device which comprises: a first suction cup for the first printing film; a second suction cup, arranged offset with respect to the first suction cup in the axial direction, for the second printing film; and a system for charging the suction cups with a negative pressure or relieving the negative pressure, independently of each other.

This application is the U.S. national phase application of PCT International Application No. PCT/EP2005/004937, filed May 6, 2005, which claims priority to German Patent Application No. DE 10 2004 023 434.5, filed May 10, 2004.

### BACKGROUND OF THE INVENTION

1. Technical Field

The invention relates to a suction device for a printing block serving to transfer colour or for another exchangeable film of a film carrier of a printing machine.

2. Description of the Related Art

U.S. Pat. No. 4,727,807 proposes using a robot for assembling and disassembling a printing block, a robot arm of said robot comprising suction cups for holding the printing block. The robot takes up a lot of space in the printing machine. In addition, it can only handle one printing block at a time.

A suction device for assembling and disassembling printing blocks is also known from U.S. Pat. No. 5,806,431 and U.S. Pat. No. 5,709,150. The suction device comprises multiple suckers next to each other along an axis, and rollers arranged between them. In order to take up the printing blocks, the suckers are pressed onto the printing blocks, such that the suckers form sealed suction chambers with the printing blocks. The suction chambers are charged with a negative pressure, thus generating the suction forces required for holding the printing blocks. In order to be able to handle the individual printing blocks independently of each other, the suction cups provided per printing block are each arranged such that they can be advanced towards the respective printing block and retracted from it independently of the suction cups for the other printing blocks. An actuating means is correspondingly provided for each printing block, in order to effect the advancing and retracting movement. Accordingly, multiple groups of suction cups, each with its own actuating means for advancing and retracting, are arranged next to each other along a crossbar extending in the axial direction of the respective printing cylinder. Each of the printing block carriers of the printing machine fitted with exchangeable printing blocks is provided with a suction device of its own. While the suction device does allow multiple printing blocks arranged next to each other on the printing block carrier to each be handled simultaneously, it is however mechanically complex and still requires a comparatively large amount of space, directly on the respective printing block carrier.

### SUMMARY OF THE INVENTION

It is an object of the invention to provide a simple suction device for handling multiple printing films which is inexpensive and requires little space. The suction device is intended to enable printing films serving to transfer colour to be economically changed in a printing machine.

The invention relates to a printing machine comprising at least one printing film carrier, preferably a colour-transferring printing cylinder, on which a first printing film and at least a second printing film can be applied, offset with respect to each other in the axial direction. The at least two printing films can be applicable directly next to each other in the axial direction. If multiple printing films can also be arranged next to each other on the printing block carrier, transverse to the axial direction, the second printing film can also be offset relative to the first printing film transverse to the axial direction—in the case of a printing cylinder, in the circumferential direction. The printing machine further comprises a suction device arranged opposite the printing film carrier. The suction device extends in the axial direction. It comprises a first suction cup for the first printing film and a second suction cup, arranged offset with respect to the first suction cup in the axial direction, for the second printing film. Furthermore, a fluidic means is provided, by means of which the suction cups for suctioning or holding the printing films can be charged with a negative pressure or relieved of a negative pressure. The word “or” is used in its usual logical sense, i.e. including the meaning of “and”.

In accordance with the invention, the first suction cup and the second suction cup can be charged with a negative pressure or relieved of a negative pressure, independently of each other, by means of the fluidic means. The suction cups of the suction device are thus fluidically separated from each other for each printing film. They do not therefore have to be mechanically separated, by being able to advance and retract mechanically independently of each other, although this possibility is not to be excluded from the outset. However, a collective suction cup mounting structure for the suction cups, on which the first suction cup and the second suction cup and—where provided—preferably also subsequent suction cups of the suction device are supported, is preferred. By mounting all the suction cups assigned to the printing film carrier in this way, a particularly space-saving suction device is obtained which moreover manages on a minimum number of actuating means for advancing and retracting the suction cups.

In a preferred first embodiment, those suction cups which are intended to take up and hold a printing film are evacuated by means of the fluidic means. For this purpose, the fluidic means can be fitted with an individual negative pressure generator, for example a pump or pressure reservoir, for each of the first and second suction cups, wherein the pressure generators can be operated independently of each other. More preferably, however, the negative pressure for each suction cup is generated by means of a collective pressure generator, and the first suction cup and the second suction cup are separated from each other by fluidic control members.

In a simplified second embodiment, the first suction cup and the second suction cup are passively formed, each as an elastically deformable suction cup, and generate the negative pressure themselves. As is known from suction cups in other applications, such a suction cup is pressed onto the printing film of the printing film carrier which is to be carried and is thus elastically compressed. If the suction cup is relieved or a tensile force is exerted counter to the pressing direction, the suction cup expands again due to its elastic restoring forces or at least due to the tensile force. Correspondingly, its cup volume increases again. Since the suction cup is pressed onto the printing film in a circumferential seal, the cup volume increases when the suction cup expands but the enclosed mass of air remains constant, such that the suction cup is suctioned fast on the printing film and can lift a weight corresponding to the suction force arising. Active evacuation can be omitted. The price of the suction device and the operating costs are reduced.

Both when using the active suction cups which operate with an external negative pressure generator and when using the passive suction cups which generate the negative pressure themselves, the suction cup or multiple suction cups which are not intended to suction a printing film are advantageously ventilated by being connected to the atmosphere or actively charged with a positive pressure, while the suction cup or cups which are intended to suction a printing film are charged with the negative pressure generated by the pressure generator or generate the required negative pressure themselves by elastically compressing and then expanding. Where preferred features of the invention are described in the following with respect to just a single suction cup, the embodiments also advantageously apply to the at least one other suction cup and even more preferably to each subsequent suction cup of the suction device.

The suction connection is fluidically released by increasing the pressure in the cup volume. This can be realised by connecting the cup volume to a pressure reservoir, pump or compressor of the fluidic means, in order to charge the cup volume with a positive pressure which is increased relative to atmospheric pressure. In an alternative embodiment, however, the cup volume can instead quite simply be evacuated to the ambient pressure. A simple short-circuit to the atmosphere represents the simplest and most inexpensive solution; actively charging with pressure represents a particularly reliable solution. A fluid conduit feeding into the cup volume and a fluidic control member assigned to the fluid conduit are provided for fluidic inactivation. For activating the suction cup and maintaining the active state, the fluidic control member can assume a closing position in which it closes the fluid conduit, such that the suction cup can form the negative pressure chamber with the printing film to be suctioned. The fluidic control member can in particular be a two-way control member which can be switched back and forth between the closing position and a flow position. It can, however, also be a non-incrementally adjustable fluidic control member or a multi-way control member with more than two different switching positions. In particular, it can be an electrically or magnetically controllable regulating valve. What has been said above applies both to an active and to a passive suction cup. In the case of an active suction cup, such a fluidic control member can be used to connect the suction cup for suctioning to a negative pressure generator and, for inactivation, to the atmosphere or to a pressure generator. For generating the negative pressure and for ventilating, separate fluid conduits for each suction cup can be provided, in each of which a fluidic control member is arranged. More preferably, separate fluid conduits are assigned a collective fluidic control member which in a first switching state closes one of the fluid conduits and opens the other, and in another switching state reverses the conditions. The fluidic control member or multiple fluidic control members of the suction device is/are preferably arranged outside of the axial section of the printing film carrier which can be occupied by printing films. Even more preferably, it/they is/are arranged laterally, as viewed from the printing film carrier, behind a casing of a machine frame.

In the case of an active suction cup, its negative pressure is preferably generated by means of a Venturi nozzle. The fluid conduit connects the cup volume to a flow cross-section through which pressurised fluid flows, i.e. it branches off from the flow cross-section through which the fluid flows, preferably at a point of narrowest cross-section. The pressurised fluid can advantageously be the pressurised fluid, in particular pressurised air, normally provided at the usual positive pressure at the location of the printing machine. The negative pressure can thus be generated by means of a fluid at a positive pressure, in that the static pressure of the Venturi nozzle through which the fluid flows forms the negative pressure.

The suction device preferably comprises at least two mounting structures, namely a crossbar which supports the entire suction device, preferably on a frame portion of the printing machine, and another mounting structure which is supported on the crossbar and can be moved relative to the crossbar in an advancing and retracting direction. The force required for the advancing and retracting movement can be generated mechanically, for example by means of an electric motor, or more preferably fluidically. Generating the force pneumatically is then in turn preferable to generating it hydraulically.

In a preferred embodiment, the suction device comprises a roller assigned to the suction cup, using which the suction device can be rolled over the printing film when the suction cups are retracted, which is in particular advantageous for applying the printing film on the printing film carrier and when rolling the printing film off from a cylindrical printing film carrier.

For mounting the suction cup and the roller, the other mounting structure is sub-divided in a preferred embodiment into a suction cup mounting structure and a roller mounting structure. The suction cup mounting structure and the roller mounting structure can each be moved relative to the crossbar and relative to each other in the advancing and retracting direction. Preferably, both the suction cup mounting structure and the roller mounting structure are supported directly on the crossbar. In principle, however, it is also possible to support one of the two mounting structures on the other, i.e. to support it on the crossbar via the other. The roller mounting structure mounts the roller such that it can rotate about an axis pointing transverse to the advancing and retracting direction. The suction cup is fixed to the suction cup mounting structure, wherein the fixation can be rigid or can permit movements by the suction cup relative to the suction cup mounting structure, for example spring-deflecting or a pivoting movement, providing however it is ensured that the functions of suctioning fast and carrying the printing film are fulfilled.

Preferably, all the suction cups of the suction device are supported on the suction cup mounting structure and can thus be advanced and retracted uniformly. The roller mounting structure preferably supports all the rollers of the suction device, such that they can be advanced and retracted uniformly.

The suction device preferably comprises multiple suction cups and multiple assigned rollers for handling one printing film. If, however, the suction force of a single suction cup is sufficient to securely lift the printing film, one suction cup and in principle one roller are sufficient for each printing film.

In preferred embodiments, the suction device comprises at least one suction cup per printing film, in order to be able to handle multiple printing films clamped on the printing film carrier. More preferably, it comprises a group of suction cups consisting of at least two suction cups for each printing film. Furthermore, it should comprise at least one roller for each printing film, wherein in order to apply a roller pressure which is evenly distributed over the printing film, it is also preferable here for the suction device to comprise a group of rollers, distributed over the width of the film, for each printing film. The groups of suction cups and/or groups of rollers can advantageously be controllable separately from each other, in order to be able to move them in or counter to the pressing direction.

If multiple suction cups are combined to form a group of suction cups, then a respective fluid conduit preferably feeds from each of the suction cups of the group into the cup volume, in order to be able to inactivate each of said suction cups. For releasing the suction connection, it may also be sufficient to evacuate only a portion of the suction cups per group or to charge only a portion of the suction cups per group with a positive pressure. The fluid conduits can be closed and opened for each group of suction cups by means of individual fluidic control members. More preferably, however, the fluidic control members for each group of suction cups lead to a collective group conduit which can be closed and opened by means of fluidic control member provided for the group, such that only one fluidic control member is required for each group of suction cups.

The suction device is preferably fixedly incorporated into the printing machine, i.e. is a fixed component of the printing machine. However, this is not to say that the suction device cannot be disassembled from an attached location and reassembled at another location by means of quick-assembly. The invention also however relates to a suction device only provided for incorporation into a printing machine, either for a new machine or for a machine which is to be retro-fitted with the suction device.

The printing film to be handled by means of the suction device can in particular be a printing block, preferably a printing plate, which is tensed onto a form cylinder or provided for a form cylinder. In principle, however, the suction device can also serve to handle other printing films, for example a rubber blanket for or on a rubber blanket cylinder. Although the invention is primarily geared for being used for rotary printing machines, and therein in particular for roller printing machines, preferably in wet offset printing, it is advantageous for use in printing machines generally and not only in rotary ones.

If all the suction cups of the suction device are fixed to a collective suction cup mounting structure or all the rollers are fixed to a collective roller mounting structure, an actuating means for advancing and retracting the suction cups or an actuating means for advancing and retracting the rollers can advantageously be arranged outside of the axial section of the printing film carrier extending in the axial direction, preferably on the crossbar mentioned. Arranging the actuating means laterally next to the printing film carrier further reduces the space requirement within the axial section which can be occupied by printing films. The space requirement laterally next to said axial section is generally not as critical. This arrangement of the actuating means is particularly advantageous for rotary printing machines, since the suction device can then be arranged particular near to the respective printing gap, and in such an arrangement obstructs the other operations on the respective printing mechanism less than the conventional suction devices.

In a preferred development, the suction device, the printing films and a clamping means of the printing film carrier, by means of which the printing films can be fixed on the printing film carrier, are adjusted to each other such that the printing films can be released from the clamping means solely by means of a tensile force exerted by the suction device on one end of the printing film. The clamping means comprises at least one respective clamping piece for each printing block, comprising a clamping area via which it clamps the end of the printing block in co-operation with a counter area. The invention prefers clamping pieces which in addition to the clamping area comprise a supporting area on which the clamping piece in question is supported in the radial direction of the printing cylinder, such that the clamping piece cannot become wedged with the clamped end of the printing block when the end of the printing block is drawn out of the tensing channel by means of suction device. In this respect, it is also advantageous if the end of the printing block is planar and angled at right angles or at an even more obtuse angle, such that it is only held in a frictional lock and not additionally also in a positive lock in a hinge by means of the clamping means, and is also not bent. It is particularly advantageous if the direction in which the suction cups are advanced and retracted is at least substantially parallel to the clamped ends, such that when the printing blocks are released, at least substantially only tensile forces act in the ends of the printing blocks in question. If the end of the printing block is angled at right angles, the advancing and retracting direction of the suction cups is advantageously radial with respect to the rotational axis of the printing cylinder. If the end is angled at an angle greater than 90°, it is advantageous if the advancing and retracting direction also comprises a direction component pointing tangentially with respect to the printing cylinder.

### BRIEF DESCRIPTION OF THE DRAWINGS

An example embodiment of the invention is explained below on the basis of figures. Features disclosed by the example embodiment, each individually and in any combination of features, advantageously develop the subjects of the embodiments described above. There is shown:

FIG. 1 is a perspective view onto a printing mechanism of a printing machine, with a suction device incorporated;

FIG. 2 is an axial section of the suction device;

FIG. 3 is a schematic diagram of a circuit for deactivating a group of suction cups of the suction device;

FIG. 4 is a section view illustrating a tensing channel comprising a clamping means for fixing an end of a printing block in a clamp; and

FIG. 5 is a cross-section of a suction device.

### DETAILED DESCRIPTION

FIG. 1 shows a view into a printing tower of a roller rotary printing machine operating in wet offset. Two printing block cylinders 1—in the example embodiment, plate cylinders—of two printing mechanisms can be seen, which are arranged on top of each other in the printing tower and operate on the same side of a printing web which passes through the printing tower. The printing block cylinders 1 are each covered by multiple printing blocks 2—in the example embodiment, printing plates—arranged axially next to each other, in a way known in its own right.

The printing block cylinders 1 are each assigned a suction device 5. The other printing block cylinders of the printing machine are each individually assigned a suction device 5 in the same way. In, for example, an octet printing tower comprising four printing bridges, arranged on top of each other, for primary and secondary printing and accordingly eight printing block cylinders 1, at least eight suction devices 5 are thus also arranged. Each of the suction devices 5 extends over the entire length of the assigned printing block cylinder 1 and is capable of handling, i.e. suctioning, all the printing blocks 2 of the assigned printing block cylinder 1. Only one of the suction devices 5, representing the others, is described in the following.

The suction device 5 comprises a crossbar 6 which extends over the entire length of the assigned printing block cylinder 1 and at its two axial ends is fixedly assembled on lateral frame portions 4. The crossbar 6 forms a narrow, elongated mounting beam clamped fixedly on both sides. The crossbar 6 serves as a carrier for multiple suction cups 10 and rollers 1 1. The suction cups 10 and rollers 11 are arranged in a row next to each other along the crossbar 6, parallel to the printing block cylinder 1, each of the suction cups 10 between two of the rollers 11. The suction device 5 is fitted with two suction cups 10 and three rollers 11 for each printing block 2. The suction cups 10 and rollers 11 form a group 10, 11 of suction cups/rollers for each printing block 2. The suction device 5 forms identical groups 10, 11 of suction cups/rollers, axially next to each other, in numbers corresponding to the number of printing block 2 arranged next to each other on the printing block cylinder 1. The groups 10, 11 of suction cups/rollers can be moved in and counter to a pressing direction directed onto the respective printing block 2, i.e. can be advanced and retracted. The suction cups 10 can be moved in and counter to the pressing direction relative to the rollers 11 and rollers 11 can be moved in and counter to the pressing direction relative to the suction cups 10. The pressing direction points at least substantially radially onto the rotational axis of the assigned printing block cylinder 1.

FIG. 2 shows an axial end section of the suction device 5, separated from the machine, for example in a state provided for incorporation. The suction cups 10 are axially elongated and each form a cup volume which is correspondingly axially elongated. They are oval in the example embodiment, each comprising a linear middle section and semi-circular ends. The suction cups 10 are elastic in shape and material. The suction cups 10 are elastically compressed by pressing onto the printing block 2. If the pressing force is removed, the suction cups 10 elastically re-expand. This expansion expands the cup volume enclosed between the printing block 2 and the wall of the suction cups 10, such that a positive pressure arises in the enclosed cup volume since the rim of the cup contacts the printing block 2 in an air-tight seal, and a particular suction force thus arises between each of the suction cups 10 and the printing block 2. If a tensile force directed away from the printing block 1, preferably a tensile force directed counter to the pressing direction, is exerted on the suction cups 10, this can lead to a further increase in volume and thus to an amplified suction force. In terms of their size, shape and material, the suction cups 10 are configured such that the sum of the suction forces of the suction cups 10 per group is sufficient to securely hold one printing block 2. The suction force per group is also sufficiently large that the respective printing block 2 can be suctioned at one end by means of the suction device 5 and drawn out of a tensing channel of the printing block cylinder 1 without additional tools or manual support. If the suction device 5 were only provided with one suction cup for each printing block 2, this suction cup would of course have to be dimensioned such that its suction force is sufficient for this purpose. Where there are more than two suction cups per group, the individual suction cup can be dimensioned to be correspondingly weaker and/or smaller.

Each of the suction cups 10 is connected to the immediate atmosphere of the suction device 5 via a fluid conduit 12. The ports of the fluid conduits 12 into the cup volumes can be seen in FIG. 2. Each of the fluid conduits 12 feeds centrally into the cup volumes, extending from their ports, over the shortest distance through the fixing region of each of the suction cups 10. For suctioning and holding the printing block 2, the fluid conduits 12 are closed. The cup volumes can be short-circuited to the atmosphere via the fluid conduits 12 and thus deactivated or inactivated in advance.

The rotational axes of the rollers 11 are parallel to the rotational axis of the assigned printing block cylinder 1, such that when the suction device 5 is assembled, they can roll off on the printing blocks 2 of the assigned printing block cylinder 1 in the circumferential direction of the assigned printing block cylinder 1, as is desirable for rolling over a printing block 2 in order to fix it and for transporting the printing block 2 when rolling off from the printing block cylinder 1.

The suction device 5 forms a multi-part mounting structure consisting of the crossbar 6 already mentioned and also a roller mounting structure 7 and a suction cup mounting structure 8. The crossbar 6 serves to fix the suction device 5 in the machine frame. The rollers 11 are fixed to the collective roller mounting structure 7 which is supported on the crossbar 6. The roller mounting structure 7 extends over the entire axial length of the printing block cylinder 1 which can be occupied by printing blocks 2. It is formed as a beam which is rigid in its own right and from which columns project in the pressing direction, on which the rollers 11 are rotationally mounted. Within the groups 10, 11 of suction cups/rollers, the suction cups 10 form a group of suction cups. The suction cups 10 are collectively supported on the suction cup mounting structure 8 which extends over the entire axial length of the printing block cylinder 1 which can be occupied by the printing blocks 2. The suction cup mounting structure 8 is directly supported on the crossbar 6 and can be advanced relative to it towards the printing block cylinder 1 and retracted from the printing block cylinder 1. The same applies to the roller mounting structure 7. Instead of supporting the two mounting structures 7 and 8 directly on the crossbar 6, as is preferred, one of the two mounting structures 7 and 8 could also be supported on the crossbar 6, but only via the other. Although less preferred, the possibility is not however to be excluded that a separate mounting structure 8 or a separate mounting structure 7 is provided for each group of suction cups or for each group of rollers and that each of the mounting structures 7 and 8 can be advanced and retracted independently of the others.

In order to only activate those suction cups 10 which are intended to suction and hold one of the printing blocks 2, the groups of suction cups assigned to each one of the printing blocks 2 are pneumatically separated. In order pneumatically separate them, those suction cups 10 which are not intended to suction a printing block 2 are short-circuited to the atmosphere A (FIG. 3) and thus set to be inactive, while the other suction cups 10 for the purpose of suctioning and holding the printing block 2 or multiple printing blocks 2 are fluidically separated from the atmosphere A.

The mounting structures 7 and 8 are moved fluidically, preferably pneumatically as in the example embodiment. An actuating means 15 is provided for advancing and retracting the mounting structure 7 and an actuating means 16 is provided for advancing and retracting the mounting structure 8. The actuating means 15 and 16 are connected to a pressurised air reservoir such as is usually provided on site for printing machines. The mounting structures 7 and 8 are each moved individually by means of actuators—in the example embodiment, pneumatic cylinders—of the actuating means 15 and 16. The control members of the actuating means 15 and 16 are preferably two-way valves, the switching state of which is controlled by an—expediently electronic—controller. The electronic controller presents the possibility of being able to manually operate the suction device 5 in question directly on site.

In order to keep the suction device 5 flat in the pressing direction, the crossbar 6 which extends in the form of a beam in the axial direction and the roller mounting structure 7 are U-profiles which are open towards the assigned printing block cylinder 1. When inserted, the U-profile of the crossbar 6 at least substantially accommodates the roller mounting structure 7. At least when inserted, the suction cup mounting structure 8 is accommodated in the U-profile of the roller mounting structure 7. Alternatively, the suction cup mounting structure 8 can be formed as a U-profile instead of the roller mounting structure 7, and accommodate the mounting structure 7. It is also possible to form all three mounting structures 6, 7 and 8 as U-profiles. The term “U-profile” is also intended to include other trough-shaped profiles, for example a V-profile or H-profile, although the latter is less preferred since it takes up more height. In principle, at least two of the mounting structures 6, 7 and 8 or as applicable even all three mounting structures 6, 7 and 8 could each be formed as thin plates which are just simply elongated radially with respect to the printing block cylinder 1. The lateral limbs of the U-profile, however, advantageously act as stiffeners. In principle, it is also not necessary for the crossbar 6 to accommodate one or both of the two other mounting structures 7 and 8. Rather, the crossbar 6 can in principle also be accommodated by one or both of the two other mounting structures 7 and 8. The nested arrangement with at least partial overlapping enables a particularly flat design of the suction device 5, radially with respect to the printing block cylinder 1.

FIG. 3 shows a pneumatic circuit for inactivating an individual group of suction cups 10. The suction cups 10 are evacuated, or more specifically ventilated to the ambient pressure, by being short-circuited to the atmosphere A, i.e. the surrounding atmosphere. The fluid conduits 12 branch off from collective group fluid conduit 13 to the individual suction cups 10 of the group and each feed into one of the cup volumes. A two-way magnetic valve is arranged in the group fluid conduit 13 as a fluidic control member 14 which in one of its two switching states closes the group fluid conduit 13 such that the cup volumes of the group of suction cups are fluidically separated from the atmosphere A, and in its other switching state opens the group fluid conduit 13 such that the short-circuit to the atmosphere A is established. The fluidic control member 14 is controlled in accordance with the actuating and control members for the mounting structures 7 and 8 by the electronic controller mentioned in connection with the actuating means 15 and 16. The moved actuating unit of the fluidic control member 14 is biased into the closing position by an incorporated spring.

A printing block 2 is changed semi-automatically by means of the suction device 5, i.e. partly manually by an operator and partly automatically by the suction device 5 assigned to the printing block 2, corresponding to the operating by the operator on site.

Once the printing block cylinder 1 has been rotated, by pressing a key, into a position which is favourable for manual access and comprises its one tensing channel or one of multiple tensing channels provided in a distribution over the circumference of the cylinder, the operator preferably places the leading end of the printing block 2 in the tension channel of the printing block cylinder 1. The subsequent tensing process, namely winding the printing block 2 and placing the other end of the printing block, is performed automatically by means of the suction device 5. For this purpose, the rollers 11 of the assigned group 10, 11 of suction cups/rollers are pressed against the printing block 2, by the operator pressing a key in order to extend the roller mounting structure 7 provided for said group 10, 11 or for all the groups 10, 11. Furthermore, the printing block cylinder 1 is rotated forwards, by pressing a key. When it is rotated forwards, the rollers 11 roll over the printing block 2 and apply it to the surface of the printing block cylinder 1. The rollers 11 roll over the trailing end of the printing block 2 such that it is pressed into the tensing channel or into another tensing channel of the printing block cylinder 1 and is thus automatically fixed, preferably in a clamp.

In order to disassemble the printing block 2, the printing block cylinder 1 is rotated into a position in which one of the two ends of the printing block 2 comes to rest radially beneath the suction device 5, preferably the trailing end of the printing block 2 in the printing operation. With the printing block cylinder 1 in position, the operator presses a key in order to press the group of suction cups 10, assigned to the printing block 2 to be removed, against the printing block 2. The suction cups 10 of the group in question or—in the preferred mounting variant—all the suction cups 10 are elastically compressed by the pressure of the pressing force. If all the suction cups 10 of the suction device 5 are extended collectively, those groups of suction cups which are intended to suction a printing block 2 are set to be active, and the others are set to be inactive, by means of the fluidic control members 14. The previously pressed suction cups 10 are then moved back, counter to the pressing direction, again by pressing a key or by automatic sequence controlling, such that the suctioned end of the printing block 2 is lifted out of the tensing channel. The suctioned end of the printing block is then hanging on the suction device 5. The operator takes on the suctioned end and deactivates the suction cups 10 by pressing a key which evacuates them. The printing block cylinder 1 is rotated back, while the operator holds the printing block 2 until the leading end of the printing block 2 can be gripped by the operator is drawn out of its tensing channel.

In an alternative embodiment, the suction device 5 is not provided with passive suction cups but rather active suction cups 10, and a negative pressure generator by means of which the cup volumes can be siphoned, in order to suction and hold the printing blocks 2. The negative pressure generator can be connected to the individual suction cups 10 via the group fluid conduits 13 and fluid conduits 12. Alternatively, siphoning conduits are provided in addition to the evacuating conduits 12 and 13. Furthermore, as an alternative to a simple short-circuit to the atmosphere, the suction cups 10 can also be charged with a positive pressure relative to the ambient pressure. It is particularly preferred if those suction cups 10 which are intended to take up and hold a printing block 2 are siphoned and those suction cups 10 which are not intended to simultaneously also exert a holding function are charged with a positive pressure, in order to particularly reliably prevent a printing block 2 from being suctioned by the suction cups 10 in question.

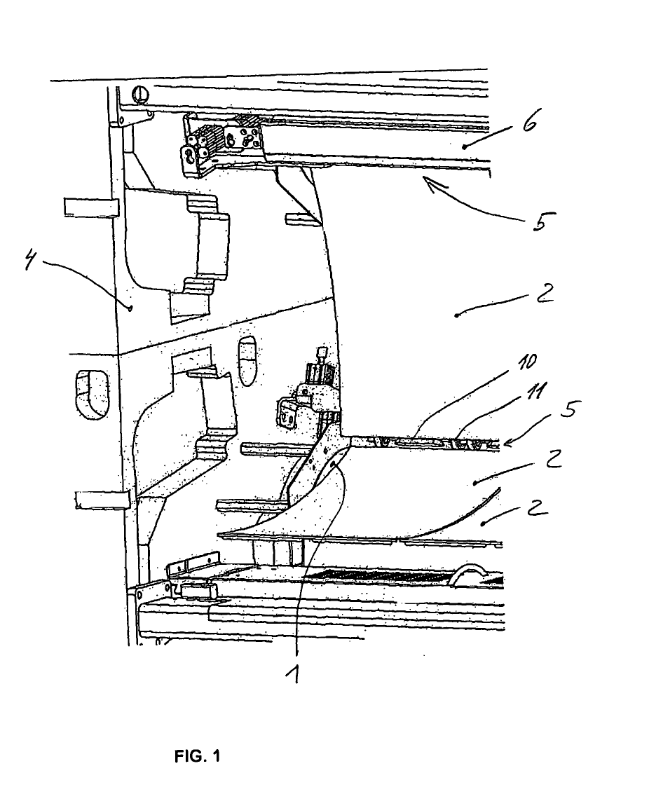

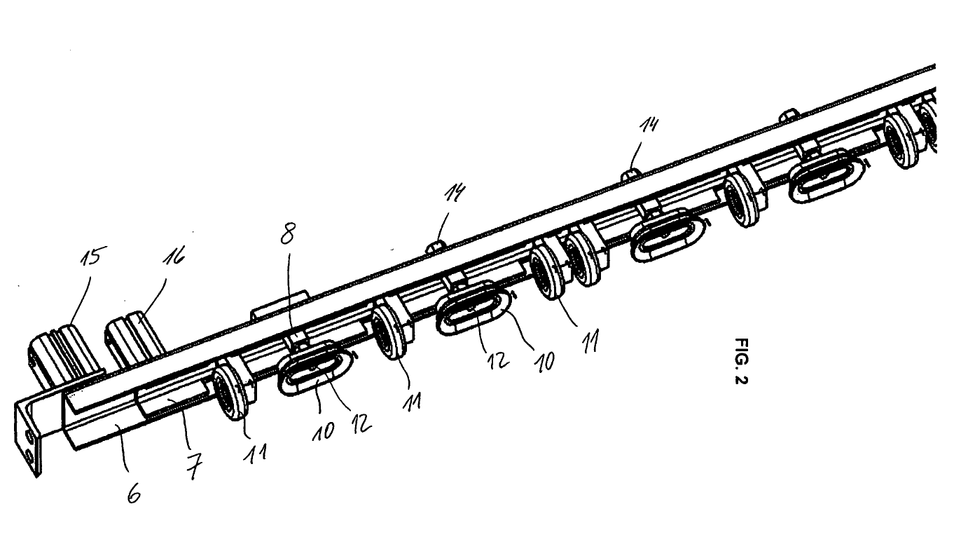

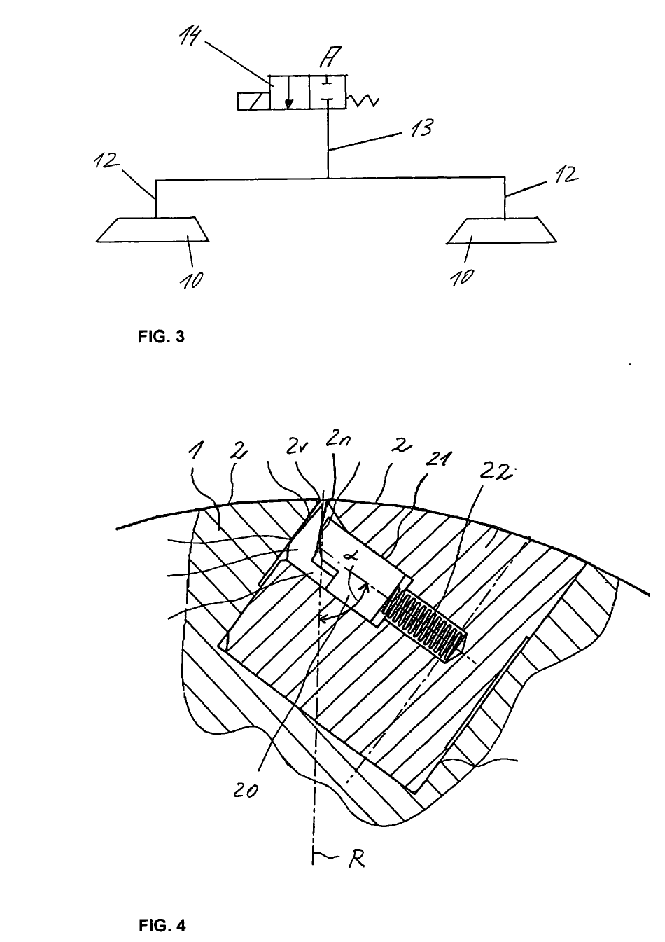

FIG. 4 shows one of the tensing channels of the printing block cylinder 1 in a cross-section. A clamping means is arranged in the tensing channel, by means of which a leading end 2v of a printing block 2 and a trailing end 2n of the same printing block 2 or another printing block 2 are fixed in the tensing channel in a clamp. The clamping means is described in German patent application No. 10 2004 042 342.3, to which reference is made in this respect. The trailing end 2n is angled at an angle of slightly over 90° and protrudes via the angled flange at least substantially into the tensing channel, i.e. with a deviation of not more than 20° to the radial onto the rotational axis of the printing block cylinder 1. The angled flange of the end 2n of the printing block 2 is planar and is not deformed by the clamping means but rather merely clamped in a frictional lock. The suction cup mounting structure 8 is supported on the crossbar 6 such that it can be advanced towards the printing block cylinder 1 and retracted from the printing block cylinder 1, at least substantially parallel to the angled flange. Once the suction cups 10 which are assigned to the printing block 2 comprising the end 2n have been suctioned fast, the angled flange is therefore subjected at least substantially only to tensile forces during the retracting movement of the suction cups 10.

The angled flange of the end 2n of the printing block 2 is clamped by means of a clamping piece 20 of the clamping means which is movably mounted in the tensing channel and comprises a clamping area, contacting the flange, for linear contact and additionally a supporting area, and is supported on the supporting area, radially with respect to the rotational axis of the printing block cylinder 1. More specifically, the clamping piece 20 is guided in a guide 21 of the printing block cylinder 1, at least substantially in a tangential direction. As a result, the clamping piece only exerts on the clamped flange of the end 2n of the printing block 2 a clamping force determined by the strength of a spring 22. The spring 22 acts in the direction of the guide 21. The guide 21 points outwards, obliquely with respect to the radial R of the printing block cylinder 1 and encloses an acute angle α of more than 45° with the radial R; in this sense, the guide runs at least substantially tangentially with respect to the rotational axis of the printing block cylinder 1, such that jamming is prevented when removing the flange.

The trailing end 2n of the printing block 2 can in particular be drawn out of the tensing channel solely due to the suctioning action of the suction device 5 and without additionally activating the clamping means.

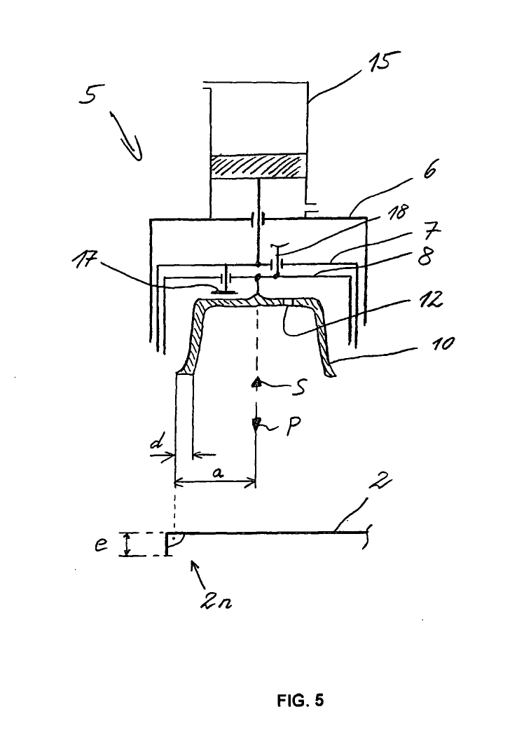

FIG. 5 shows the nested arrangement of the mounting structures 6, 7 and 8 and further details regarding the suction cups 10. The actuating means 15 for the roller mounting structure 7 is shown. The pneumatic actuator of the actuating means 16 for the suction cup mounting structure 8 is not shown; the connection to its actuator is merely indicated by 18.

The suction device 5, in particular the suction cup 10 shown to represent the others, is shown with respect to a printing block 2 in its advanced position, after the trailing end 2n has been suctioned. The suction force S acting on the printing block 2 along the axis P-S of the advancing and retracting movement acts as proximately as possible on the angled trailing end 2n of the printing block 2. The distance between the axis P-S and the edge of the trailing end 2n is selected to be as small as possible. For this purpose, the suction cup 10 is configured in a particular way. The contact area of the suction cup 10 facing the printing block 2 exhibits a maximum distance a from the movement axis P-S, as measured between the movement axis P-S and the outer circumferential rim of the suction cup 10, on its side facing the angled end 2n, said distance measuring 20 mm at most, preferably 15 mm at most. Apart from a slight distance from the edge of the trailing end 2n which the suction cup 10 exhibits on its outer circumferential rim, the suction force S acts at the distance a from the edge of the trailing end 2n. The thickness d of the contact area, as measured transverse to the axial direction P-S of the printing block cylinder 1, should not measure more than 8 mm, preferably not more than 5 mm, at least in the region of the suction cup 10 nearest to the edge of the trailing end 2n.

The ability of the printing block 2 to be removed solely by means of the suction device 5 is further benefited if the angled flange exhibits as small a length e as possible. The flange length e should not measure more than 14 mm and preferably measures 10 mm at most. The angled flange encloses a right angle with the printing block 2 which is planar when unbiased. The suction force S, which coincides with the direction of the retracting movement, points parallel to the angled flange. When the trailing end 2n is drawn out of the tensing channel of the printing block cylinder 1, at least substantially—ideally, exclusively—tensile forces therefore act in the angled flange.

Removing the end 2n of the printing block 2 is also benefited if, when removing it, the roller mounting structure 7 is first accelerated in the direction S by means of the actuating means 15 and in this movement comes into abutting contact with the suction cup mounting structure 8—which at this time is not yet in motion—by means of an abutting element 17, such that an impact force acting in the direction S acts on the suction cup mounting structure 8. The impact force is advantageous in order to overcome the static friction acting on the clamped flange of the end 2n of the printing block 2. In FIG. 5, the abutting element 17 is shown as an additional element, which is due to the suction cup mounting structure 8 being completely or partially accommodated in the roller mounting structure 7, at least when inserted. If this arrangement were reversed, i.e. the roller mounting structure 7 at least partially accommodated in the then surrounding suction cup mounting structure 8, the base of the U-profile forming the roller mounting structure 7 would replace the abutting element 17.

In FIGS. 1 and 2, the actuating means 15 and 16 are arranged on the side of the crossbar 6 opposite the mounting structures 7 and 8. To save space, the actuating means 15 and 16 or at least one of the actuating means 15 and 16 can also instead be arranged on the same side as the mounting structures 7 and 8 and project from the crossbar 6 in the direction of the advancing and retracting movement of the suction cups 10 and rollers 11.

The suction device 5 is fitted with two pneumatic actuators for each of both the roller mounting structure 7 and the suction cup mounting structure 8. One of the actuators in each case is attached outside of the axial section of the printing block cylinder 1 which can be occupied by printing blocks 2, in the two axial end regions of the crossbar 6. In the example embodiment, the two pairs of actuators are arranged on both sides of the printing block cylinder 1, in its two pivot regions. If the printing block cylinders 1 are fitted with bearing rings, as in the example embodiment, then the actuators and preferably the other fluidic members of the actuating means 15 and 16 are each arranged on the outside, laterally with respect to the bearing rings, such that they do not take up any space over the circumferential area of the cylinder, in particular in its axial section which can be occupied by printing blocks 2. The fluidic control members 14 and, as applicable, other fluidic control members are arranged behind the casing of the machine frame 4. Only the fluid conduits run between the actuating means 15 and 16 arranged on both sides of the printing region.

When using active instead of passive suction cups 10, Venturi nozzles are formed directly at the suction cups 10, in order to generate the negative pressure by means of the usual air pressure of the air pressure system provided on site, either one Venturi nozzle for each suction cup 10 or for each group of suction cups. The above embodiments relating to passive suction cups otherwise preferably apply to suction devices comprising active suction cups. Suctioning by elastically expanding the cup volumes is merely replaced by actively suctioning by charging with a negative pressure, i.e. evacuating.

1. A printing machine comprising a printing film carrier on which a first printing film and a second printing film can be applied, offset with respect to each other in an axial direction, and comprising a suction device which comprises:
a) a first suction cup for the first printing film;
b) a second suction cup, arranged offset with respect to the first suction cup in the axial direction, for the second printing film; and
c) a fluidic means for charging the suction cups with a negative pressure or relieving the negative pressure, independently of each other.

2. The printing machine according to claim 1, further comprising a crossbar extending in the axial direction and a suction cup mounting structure supported on the crossbar, on which at least one of the suction cups is held and which can be advanced towards the printing film carrier and retracted from the printing film carrier relative to the crossbars.

3. The printing machine according to claim 2, wherein the crossbar comprises, in cross-section, a profile which is open towards the printing film carrier, in which the suction cup mounting structure is accommodated at least over a major portion of its height as measured in the advancing and retracting directions in a position retracted from the printing film carrier.

4. The printing machine according to claims 2, further comprising a suction cup actuating means for advancing and retracting the suction cup mounting structures.

5. The printing machine according to claim 4, wherein the suction cup actuating means is arranged, in the axial direction, outside of an axial section of the printing film carrier which takes up the printing films.

6. The printing machine according to claims 4, further comprising a controller which controls the suction cup actuating means and the fluidic means for removing the first printing film, such that the suction cups are collectively advanced and, of the first suction cup and the second suction cup, only the first suction cup is charged with a negative pressure.

7. The printing machine according to claims 4, further comprising a controller which controls the suction cup actuating means and the fluidic means for removing the first printing film, such that the suction cups are collectively advanced and the second suction cup is connected to the atmosphere or is charged with a positive pressure, while the first suction cup suctions the first printing film.

8. The printing machine according to claims 2, wherein the suction cups are collectively held on the suction cup mounting structure and can be uniformly advanced and retracted with the suction cup mounting structures.

9. The printing machine according to claim 1, further comprising:
a first roller for the first printing film;
a second roller for the second printing film;
a crossbar extending in the axial direction;
and a roller mounting structure which is supported on the crossbar and on which at least one of the rollers is held and which can be advanced towards the printing film carrier and retracted from the printing film carrier, relative to the crossbar.

10. The printing machine according to claim 9, further comprising a roller actuating means for advancing and retracting the roller mounting structure.

11. The printing machine according to claim 10, wherein the roller actuating means is arranged, in the axial direction, outside of an axial section of the printing film carrier which takes up the printing films.

12. The printing machine according to claim 9, wherein the crossbar comprises, in cross-section, a profile which is open towards the printing film carrier, in which the roller mounting structure is accommodated at least over a major portion of its height as measured in the advancing and retracting directions in a position retracted from the printing film carrier.

13. The printing machine according to claim 9, further comprising a suction cup mounting structure supported on the crossbar, on which at least one of the suction cups is held and which can be advanced towards the printing film carrier and retracted from the printing film carrier relative to the crossbar and wherein the roller mounting structure comprises an abutting element via which, when the suction cup mounting structure is advanced, the roller mounting structure comes into abutting contact with the still advanced suction cup mounting structure during a retracting movement.

14. The printing machine according to claim 9, further comprising a suction cup mounting structure supported on the crossbar, on which at least one of the suction cups is held and which can be advanced towards the printing film carrier and retracted from the printing film carrier relative to the crossbar and wherein at least one of the roller mounting structure and the suction cup mounting structure comprises a profile which is open towards the printing film carrier, in which the other of the roller mounting structure and the suction cup mounting structure is accommodated at least over a major portion of its height as measured in the advancing and retracting directions in a position retracted from the printing film carrier.

15. The printing machine according to claim 9, further comprising a suction cup mounting structure supported on the crossbar, on which at least one of the suction cups is held and which can be advanced towards the printing film carrier and retracted from the printing film carrier relative to the crossbar and wherein the crossbar, the roller mounting structure and the suction cup mounting structure are nested in each other and overlap each other at least over a major portion of their heights as measured in the advancing and retracting directions in a position of the roller mounting structure and the suction cup mounting structure retracted from the printing film carrier.

16. The printing machine according to claim 9, further comprising a suction cup mounting structure supported on the crossbar, on which at least one of the suction cups is held and which can be advanced towards the printing film carrier and retracted from the printing film carrier relative to the crossbar and wherein the crossbar is installed immovably.

17. The printing machine according to claims 1, wherein one end of each of the printing films comprises an angled flange which is planar, at least when unbiased, and via which the respective printing film can be fixed, clamped on the printing film carrier, in a tensing channel of the printing film carrier, and wherein the suction cups can be retracted in a direction which points at least substantially parallel to the flange, such that when the respective printing film is released, at least substantially only tensile forces act in its flange.

18. The printing machine according claim 17, wherein the flange is only clamped in a frictional lock in the tensing channel.

19. The printing machine according to claims 1, wherein the printing film carrier is a printing block cylinder, and each of the printing films comprises an angled flange via which it can be fixed, clamped on the printing film carrier, in a tensing channel of the printing film carrier, and in that a clamping means is arranged in the tensing channel, which comprises at least one respective clamping piece for the printing film which can be clamped in the tensing channel, wherein said clamping piece comprises a clamping contact area, which acts against the flange of the respective printing film, and additionally a supporting area, and is supported on the supporting area in the radial direction of the printing film carrier in order to prevent the clamped flange from becoming wedged when the respective printing film is removed.

20. The printing machine according to claims 1, wherein the suction cups are elastically deformable and, once the respective cup volume has been reduced by deformation, are suctioned fast on a respective printing film by elastically expanding.

21. The printing machine according to claims 1, wherein the fluidic means comprises fluid conduits which feed into the suction cups and fluidic control members for the fluid conduits, wherein that the fluidic control members close the fluid conduits or connect them to a negative pressure generator for suctioning the printing films, and open them for reducing the suction force.

22. The printing machine according to claim 21, wherein the fluid conduits connect the suction cups to a pressure generator or to the atmosphere for reducing the negative pressure.

23. The printing machine according to claims 21, wherein the fluidic control members are each multi-way valves which can be activated magnetically or electrically.

24. A method for removing a printing film from a printing film carrier of a printing machine, by means of a suction device according to claims 1, wherein:
a) a clamped end of the printing film is released from a clamping connection to the printing film carrier by means of an assigned suction cup;
b) an opposite end of the printing film is then released by hand;
c) and the printing film is removed by hand from the printing film carrier.

25. The printing machine according to claim 3 wherein the crossbar comprises, in cross-section, a trough-shaped profile.

26. The printing machine according to claim 12 wherein the crossbar comprises, in cross-section, a trough-shaped profile.
